(19) United States
(12) Patent Application Publication
(10) Pub. No.: US 2012/0095865 A1
(43) Pub. Date: Apr. 19, 2012

(54) System And Method For Mobile Electronic Purchasing

(75) Inventors: Thomas Cameron Doherty, Denver, CO (US); Carlin Dombush, Superior, CO (US); David Farber, Westminster, CO (US)

(73) Assignee: EZPAYY, INC., Denver, CO (US)

(21) Appl. No.: 12/905,755

(22) Filed: Oct. 15, 2010

(51) Int. Cl. G06Q 30/00

(52) U.S. Cl. 705/26.8; 705/27.1

(57) ABSTRACT

A system and method for electronic purchasing via a mobile web-enabled communication device. A contacts list containing shipping addresses, and a payment file containing encrypted credit card information for one or more credit cards is stored on the mobile device. In response to a request for credit card and shipping information from a merchant website for an item to be purchased, a specific one of the credit cards and a specific one of the shipping addresses is selected from the contacts list and the payment file, respectively. The credit card data for the selected credit card is decrypted, and the decrypted credit card data and the selected shipping address are sent to the merchant website for order processing.

### BACKGROUND

Making an Internet purchase from a mobile phone typically requires that the purchaser manually enter data such as a credit card number and shipping information. For the purchaser, this becomes tedious when using multiple eCommerce systems and websites. For merchants, there is additional work associated with accepting credit card payments when using the mobile Internet. What is needed is a system for mobile web-enabled devices (e.g., ‘smartphones’) that allows both the user and the merchant to accomplish Internet-based purchasing tasks with less time and effort than that required by present purchaser-merchant interfaces.

### SOLUTION

The present system stores multiple credit cards and uses previously entered data to simplify the data entry aspect of an online credit card transaction. Personal/payment information remains securely stored in the user's mobile phone. Furthermore, with the present system, merchants can leverage existing web assets and merchant accounts, instead of building an application for every type of ‘smartphone’. The customer's time to checkout is reduced to a relatively few clicks after an item is selected for purchase on a merchant's website. This system allows for a more uniform experience on each user's smartphone across diverse merchants' websites.

In one embodiment, a contacts list containing shipping addresses, and a payment file containing encrypted credit card information for one or more credit cards is stored on the smartphone. In response to a request for credit card and shipping information from a merchant website for an item to be purchased, a specific one of the credit cards and a specific one of the shipping addresses is selected from the contacts list and the payment file, respectively. The credit card data for the selected credit card is decrypted, and the decrypted credit card data and the selected shipping address are sent to the merchant website for order processing.

### BRIEF DESCRIPTION OF THE DRAWINGS

FIG. 1 is a diagram showing exemplary components of one embodiment of the present system;

FIG. 2 is a flowchart showing exemplary steps performed by the present system in one embodiment; and

FIG. 3 is a diagram showing exemplary data flow during operation of the present system.

### DETAILED DESCRIPTION

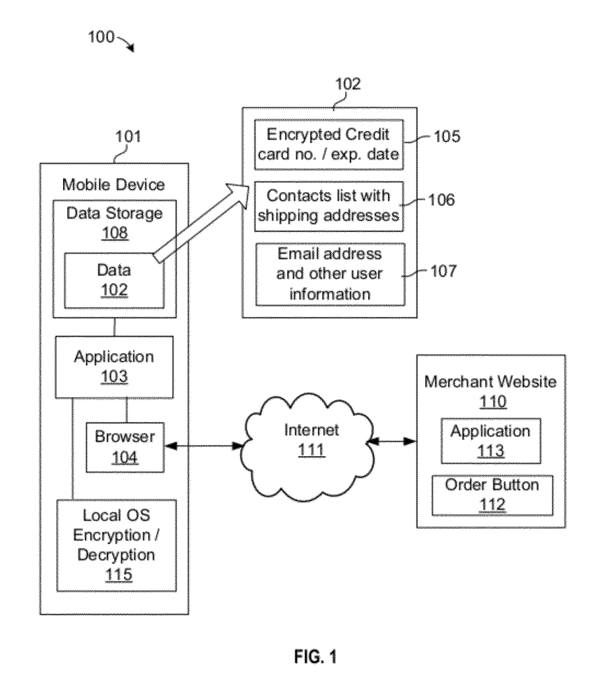

FIG. 1 is a diagram showing exemplary high-level components of the present system 100. As shown in FIG. 1, in an exemplary embodiment, the present system for mobile electronic purchasing 100 comprises a mobile web-enabled communication device (e.g., a ‘smartphone’) 101 and a merchant website 110, which are interconnected via the Internet 111.

Mobile device 101 includes a web browser 104, a transaction processing and communication application 103, and data storage area 108 containing data 102, including encrypted data 105. Data 102 includes a payment file 105 containing one or more encrypted user credit card numbers and expiration dates, a contacts list 106, and the user's email address and other user information.

In one embodiment, contacts list 106 is the same file used by an application (e.g., a browser) on mobile device 101 for determining email addresses used in sending email messages from the device.

Merchant website 110 includes an order button 112 associated with a URL that opens an application 113 which communicates with a purchaser (hereinafter system user, or simply ‘user’). The functionality of each of the entities shown in FIG. 1 is explained in detail below.

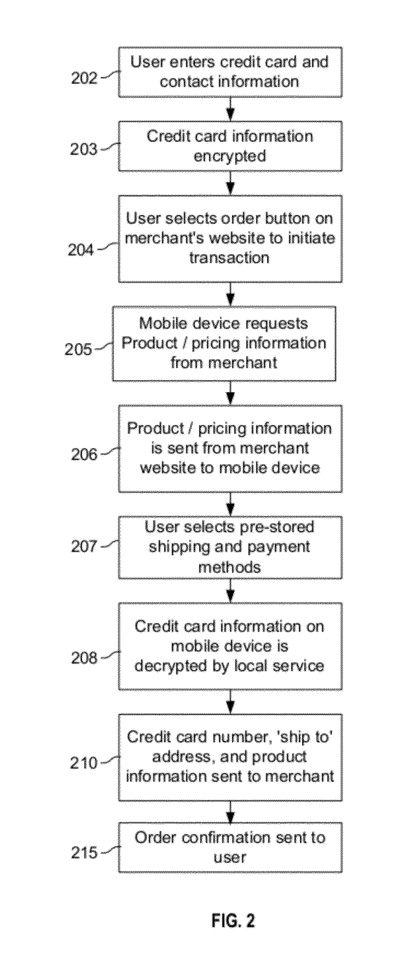

FIG. 2 is a flowchart showing steps performed by the present system in executing the purchase of an item with a credit (or debit) card using a mobile web-enabled communication device, such as a ‘smartphone’ (hereinafter ‘mobile device’), in an exemplary embodiment. As shown in FIG. 2, prior to using the present system to make a purchase, the user enters credit card information including card numbers and expiration dates for one or more credit cards, using application 103, and enters names and addresses of one or more people in a contacts list 106, at step 202. Application 103 uses a local operating system service 115 (such as Apple® iOS Keychain or Core Data Service, where the mobile device is an iPhone® or iPad®) to encrypt (and decrypt) information on the mobile device, and at step 203, encrypts and stores information for one or more credit or debit cards in payment file 105 of data store 102.

To make a purchase, the user first displays a web page on a merchant's website using web browser 104 on mobile device 101. After the user selects the item(s) to be purchased by placing the item(s) in an order list, such as a ‘shopping cart’ or the like, an order button 112 on the web page is selected (‘clicked on’) to initiate the purchasing transaction, at step 204. Merchant website 110 uses application 113 to communicate with mobile device 101. In an exemplary embodiment, application 113 is specifically adapted to send and receive product and purchase information to/from application 103 in mobile device 101.

Item information including the item price, merchant name, and item description of the selected item is then requested by the mobile device, at step 205, and the requested information is sent from merchant website 110 to mobile device application 103, at step 206.

At step 207, the user selects a shipping method including the shipping address, and a payment method (the specific credit/debit card to be used for the transaction) in response to prompt screens on device 101. The shipping method selection is made from previously entered shipping address data (from the user's contacts list 106), and a particular credit or debit card is selected from a list of cards for which data was previously entered and stored in encrypted form in file 105.

The encrypted credit card information and shipping information previously stored in the mobile device is decrypted on the mobile device by the local operating system service 115 at step 208. At step 210, the credit card number, shipping address, user's email address is sent to the merchant's website. In one embodiment (described in detail below), a URL-based mechanism is used for communication between mobile device 101 and merchant website 110.

At step 215, after the transaction has been successfully received by the merchant, a success or failure URL communication is sent to the mobile device from the merchant.

### URL-Based Communication Mechanism

Every URL consists of at least some of the following: the scheme name (commonly called protocol), followed by a colon, then, depending on scheme, a hostname (alternatively, IP address), a port number, the path of the resource to be fetched or the program to be run, then, for programs such as Common Gateway Interface (CGI) scripts, a query string. The combined syntax is:

scheme://username:password@domain:port/path?query_string#anchor

In one embodiment of the present system, encoded URLs are used for communication between a user's mobile device 101 and the merchant website 110. When browser 104 in mobile device 101 displays a web page on merchant website 110 with a ‘shopping cart’ (an order list containing items selected for purchase by the user), a purchase button image on the web page displays a message such as “Buy Now”. An HTML link to initiate execution of transaction processing application 103, may be wrapped around the purchase button image, per the example below:

<a href=″EPay://www.Merchant.com:1234/Merchant_main_{—}
page/EPayOpen_SessionID=xxx”> <img src=BuyNow.png /></a>

where “EPay” is a locally-defined protocol on device 101 which specifies the use of a secure connection, “www.Merchant.com” is the URL of the merchant website, “Merchant_main_page/EPayOpen” is the link which opens application 103 to receive user/purchase information, and “SessionID” is the merchant's session information in the query string part of the URL.

Application 103 will pass whatever it finds in the query string back to the merchant on subsequent requests so that the user's session can be identified. In an exemplary embodiment, application 103 uses the HTTPS protocol for all connections to the merchant website. ‘HTTPS’ stands for Hypertext Transfer Protocol Secure, which is a combination of the Hypertext Transfer Protocol (HTTP) with the SSL/TLS protocol to provide encrypted communication and secure identification of a network web server. Execution of application 103 may be initiated by a separate application, either resident on mobile device 101, or remotely in communication with the mobile device.

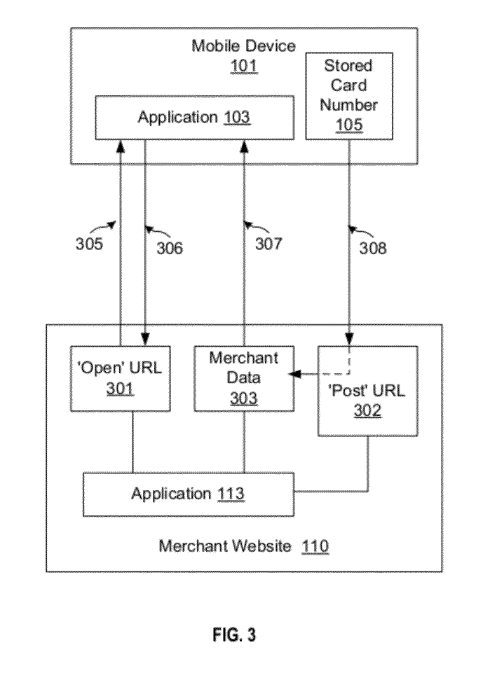

FIG. 3 is a diagram showing exemplary data flow during operation of the present system. As indicated by arrow 305 in FIG. 3, when the user clicks on the purchase button (FIG. 2, step 204), an ‘open URL’ 301, which is the target URL associated with the button, is activated, which opens application 103 on mobile device 101. The following example shows an ‘open’ URL:

EPay://www.Merchant.com:/1234/Merchant_main_page/EPayOpen_{—}
SessionID=xxx

As indicated by arrow 306, application 103 requests the shopping cart price, merchant name, and a merchant certificate via the above URL (step 205), which information is then provided by the merchant website (via application 113) in the form of a two-section mime/multipart document, with the certificate in the second section (step 206, FIG. 3 arrow 307). The Open document on the merchant's website may take the following form:

HTTP/1.1 200 OK
Cache-Control: private
Content-Length: 1589
Content-Type: multipart/mixed; boundary=“--==EPay_demo”;
charset=utf-8
Server: Microsoft-IIS/7.0
X-EPay-Version: 1.0
X-AspNet-Version: 2.0.50727
X-Powered-By: ASP.NET
X-5o9-MobileMe-SRVID: 5o9-iMobile 1.2.2.08.16.08 4.29.2010-19.11.57
Date: Thu, 29 Apr 2010 19:11:57 GMT
Price=3500&MerchantName=Merchant
--==EPay_demo
Content-Type: text/plain
Content-ID: <Certificate>
-----BEGIN CERTIFICATE-----
MIID+zCCA2SgAwIBAgIJAKflCZF0L/EWMA0GCS ...
-----END CERTIFICATE-----
--==EPay_demo--

The user then selects a shipping method including a shipping address, and a payment method, i.e., the specific credit or debit card to be used for the transaction, from the information previously stored in mobile device 101 (step 207), and enters a PIN (personal ID number). Local operating system service 115 next decrypts the previously stored shipping and credit card information for the selected shipping and payment methods (step 208). Application 103 then sends this information to the merchant site (step 210, FIG. 3 arrow 308) via a simple form post to a URL 302, which may take the following form:

EPay://www.Merchant.com:/1234/Merchant_main_page/EPayPost_{—}
SessionID=xxx

The form fields that are sent include:

Name

Phone

Email

ShippingName

Street

City

State

Zip

CreditCard

CreditCardNumber

CreditCard Expiration

The above information, including credit card number and expiration date, is stored in merchant data area 303 for processing by the merchant. At this point, merchant website 110 processes the transaction and responds with an HTTP 200 status (transaction successful) or HTTP 402 status and an error message, which is displayed to the user (step 215).

When the transaction has been completed, application 103 opens a ‘return’ URL in the user's web browser and exits. The return URL may take the following form:

EPay://www.Merchant.com:/1234/Merchant_main_page/EPayReturn_Session
ID=xxx

Having described the invention in detail and by reference to specific embodiments thereof, it will be apparent that modifications and variations are possible without departing from the scope of the invention defined in the appended claims. More specifically, it is contemplated that the present system is not limited to the specifically-disclosed aspects thereof.

What is claimed is:

1. A method for electronic purchasing via a mobile web-enabled communication device including an Internet browser, the method comprising:
creating a contacts list, stored on the mobile device, containing at least one shipping address;
creating a payment file, stored on the mobile device, containing encrypted credit card information including a card number and expiration date for at least one credit card;
displaying, via the browser, a merchant website including a web page displaying an order button;
placing the item to be purchased in an order list on the web page;
selecting the order button to cause item information including the name and price of a selected item to be purchased to be sent from the merchant website to the device;
requesting the price of the selected item from the merchant website;
receiving the price of the selected item from the merchant website;
in response to receipt of the item information from the merchant website:
selecting a specific one of the credit cards and a specific one of the shipping addresses from the contacts list and the payment file, respectively;
decrypting the credit card data for the selected credit card; and
sending the decrypted credit card data and the selected shipping address from the device to the merchant website for order processing.

2. The method of claim 1, wherein communication for the steps of requesting and sending are effected using a respective URL on the merchant website for each of the steps.

3. The method of claim 2, wherein an application which performs the steps of requesting, receiving, and selecting is initiated by the browser.

4. The method of claim 1, wherein an application which performs the steps of requesting, receiving, and selecting is initiated by another application.

5. The method of claim 1, wherein the contacts list is the file used for determining email addresses used in sending email messages from the device.

6. A method for electronic purchasing via a mobile web-enabled communication device, the method comprising:
creating a contacts list, stored on the device, containing at least one shipping address;
creating a payment file, stored on the device, containing encrypted credit card information including a card number and expiration date for at least one credit card;
in response to a request for credit card and shipping information from a merchant website for an item to be purchased, selecting a specific one of the credit cards and a specific one of the shipping addresses from the contacts list and the payment file, respectively;
decrypting the credit card data for the selected credit card; and
sending the decrypted credit card data and the selected shipping address to the merchant website for order processing of the item to be purchased.

7. The method of claim 6, wherein the step of sending is effected using a URL on the merchant website for communication between the device and the merchant website.

8. The method of claim 7, wherein an application which performs the steps of requesting, receiving, and selecting is initiated by the browser.

9. The method of claim 6, wherein an application which performs the steps of requesting, receiving, and selecting is initiated by another application.

10. A system for mobile electronic purchasing comprising:
a mobile web-enabled communication device including an Internet browser and a data storage area in which is stored (1) a contacts list including shipping addresses, and (2) encrypted credit card data including a card number and expiration date for each of one or more credit cards;
wherein:
the browser on the device displays a web page on a merchant website including an order button, that when selected, causes item information including the name and price of an item to be purchased to be sent from the merchant website to the device; and
in response to receipt of the item information sent by the merchant website:
a specific one of the credit cards and a specific one of the shipping addresses is selected from the contacts list and the credit card data, respectively; and
the credit card data for the selected credit card is decrypted, and the decrypted credit card data and the selected shipping address is sent to the merchant website for order processing.

11. The system of claim 10, wherein communication between the device and the merchant website is effected via at least one URL.

12. The method of claim 11, wherein an application which performs the steps of requesting, receiving, and selecting is initiated by the browser.

13. The method of claim 10, wherein a transaction processing application which performs the steps of requesting, receiving, and selecting is initiated by another application.

14. The method of claim 13, wherein the merchant website uses an application specifically adapted to transmit product and purchase information between the website and the transaction processing application in the device.

15. A system for mobile electronic purchasing comprising:
a mobile web-enabled communication device including a data storage area in which is stored (1) a list which includes at least one shipping address, and (2) encrypted credit card data including a card number and expiration date for each of one or more credit cards;
wherein the encrypted credit card data is decrypted, and the decrypted credit card data and the shipping address is sent from the device to a merchant website to purchase an item ordered via the website.

16. The method of claim 15, wherein the step of sending is effected using a URL on the merchant website for communication between the device and the merchant website.

17. The method of claim 16, wherein an application which performs the steps of requesting, receiving, and selecting is initiated by the browser.

18. The method of claim 15, wherein an application which performs the steps of requesting, receiving, and selecting is initiated by another application.

19. The method of claim 15, wherein the list is a contacts list that is used for sending email from the device.

20. The method of claim 15, wherein the merchant website uses an application specifically adapted to transmit product and purchase information between the website and an application in the device.
